(19) United States
(12) Patent Application Publication
(10) Pub. No.: US 2003/0099195 A1
(43) Pub. Date: May 29, 2003

(54) Method and apparatus for notifying data congestion in a communication system

(75) Inventor: Sung-Won Lee, Songnam-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/306,523

(22) Filed: Nov. 27, 2002

(30) Foreign Application Priority Data
Nov. 29, 2001 (KR) P2001-75108

(51) Int. Cl. G01R 31/08; H04L 12/28

(52) U.S. Cl. 370/229; 370/395.1

(57) ABSTRACT

A method and apparatus for determining data congestion in a communication path and notifying the data congestion in a communication system. In an apparatus for determining data congestion at a first node connected to a second node, a buffer stores transmission data. A controller compares the size of data stored in the buffer with a predetermined first threshold and a predetermined second threshold greater than the first threshold. If the buffered data size is equal to or greater than the second threshold, the controller determines that data congestion has occurred. A transmitter generates congestion indicating information and transmits it to the second node under the control of the controller. The second node then transmits to the first node a congestion indication message requesting control of the data congestion.

### PRIORITY

This application claims priority to an application entitled “Method and Apparatus for Notifying Data Congestion in a Communication System” filed in the Korean Industrial Property Office on Nov. 29, 2001 and assigned Serial No. 2001-75108, the contents of which are hereby incorporated by reference.

### BACKGROUND OF THE INVENTION 1. Field of the Invention

The present invention relates generally to data congestion control in a communication system, and in particular, to a method and apparatus for determining data congestion in a communication path and notifying the data congestion.

2. Description of the Related Art

Mobile communication systems, for example, CDMA2000 (Code Division Multiple Access 2000), WCDMA/UMTS (Wideband Code Division Multiple Access/Universal Mobile Telecommnunications System), GPRS (General Packet Radio Service), and CDMA2000 1×EV-DO (Evolution-Data Only) typically support only voice service. These mobile communication systems, however, have been developed to additionally provide data service. The ATM (Asynchronous Transfer Mode) system also supports data service. As known, the ATM system provides multimedia service by transmitting and receiving data in ATM cells.

In the mobile communication systems supporting data service and the ATM system (hereinafter, generically referred to as communication systems), communication paths are defined by a plurality of nodes. In a mobile communication system, for example, a BSC (Base Station Controller), a BTS (Base Transceiver System), and an MS (Mobile Station) serve as nodes.

Each node in a communication system is provided with a data buffer for temporarily storing data, for example, data packets or ATM cells, to be transmitted to or received from an adjacent node. If the data buffer had a limitless capacity, no problems would arise from data transmission and reception. However, due to the limited capacity of the buffer, a flow control of data transmission and reception is generally performed according to the size of buffered data. A data congestion control is a type of a flow control.

If a communication system includes a first node having a transmission buffer and a second node having a reception buffer, a conventional data congestion control is carried out as follows. First, the first node compares the size of data buffered in the transmission buffer with a predetermined threshold. If the data size is greater than the threshold, the first node determines that data is congested and transmits to the second node information indicating the data congestion, for example, an EFCI (Explicit Forward Congestion Indicator) in an ATM cell format. The indication information is contained in a header of transmission data to indicate data congestion in a current data transmission period. The second node then transmits a Congestion Indication Message to the first node, requesting control of the data congestion. Thus, the first node controls a data rate of data to be transmitted to the transmission buffer. That is, the first node performs a data congestion control by, for example, reducing a forward data rate.

However, immediately after the data congestion is relieved, the data rate is increased back to the original rate. As a result, a congestion period restarts soon thereafter. Accordingly, the interval between a congestion period and a non-congestion period is very short, if the data congestion control uses one threshold. Further, the resulting frequent data rate control leads to the increase of signaling for data congestion control. Moreover, since the internal state of the communication system is maintained at a threshold level on the whole, the probability of transmission data loss, for example, ATM cell loss, increases.

### SUMMARY OF THE INVENTION

It is, therefore, an object of the present invention to provide a method and apparatus for preventing frequent transmission data congestion control in a communication system.

It is another object of the present invention to provide a method and apparatus for preventing the increase of signaling for a data transmission flow control in a communication system.

It is a further object of the present invention to provide a method and apparatus for stabilizing system state by suppressing frequent changes in data rate in a communication system.

It is still another object of the present invention to provide a method and apparatus for reducing the probability of transmission data loss in a communication system.

To achieve the above and other objects, in an apparatus for determining data congestion at a first node connected to a second node, a buffer stores transmission data. A controller compares the size of data stored in the buffer with a predetermined first threshold and a predetermined second threshold greater than the first threshold. If the buffered data size is equal to or greater than the second threshold, the controller determines that data congestion has occurred. A transmitter generates congestion indicating information and transmits it to the second node under the control of the controller. The second node then transmits to the first node a congestion indication message requesting control of the data congestion.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a configuration of a mobile communication system to which the present invention may be applied;

FIG. 2 is a block diagram of a BSC illustrated in FIG. 1;

FIG. 3 is a block diagram of a BTS illustrated in FIG. 1;

FIG. 4 is a block diagram of a channel card illustrated in FIG. 3;

FIG. 5 is a block diagram of a data congestion notifying apparatus according to an embodiment of the present invention;

FIG. 6 illustrates a method of generating congestion indicating information according to an embodiment of the present invention;

FIG. 7 illustrates a conventional method of generating congestion indicating information

FIG. 8 is a flowchart illustrating a method of setting registers illustrated in FIG. 5 according to an embodiment of the present invention;

FIG. 9 is a flowchart illustrating received packet processing in the data congestion notifying apparatus according to an embodiment of the present invention;

FIG. 10 is a flowchart illustrating transmission packet processing in the data congestion notifying apparatus according to an embodiment of the present invention;

FIG. 11 is a flowchart illustrating a method of setting the congestion indicating information in the data congestion notifying apparatus according to an embodiment of the present invention;

FIG. 12 is a diagram illustrating a signal flow for a data congestion control when data congestion does not occur during a data transmission period according to an embodiment the present invention; and

FIG. 13 is a diagram illustrating a signal flow for a data congestion control when data congestion occurs during a data transmission period according to an embodiment the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention provides a method of determining data congestion in a communication path defined by at least two communication nodes, and notifying and controlling the data congestion in one of the communication nodes in a communication system. This method is applicable to any communication system including mobile communication systems supporting packet data transmission and the ATM system. Such mobile communication systems are IS2000 (or CDMA2000), WCDMA, UMTS, 1×EV-DO, GPRS, and 1×EV-DV. For clarity of description, the following description will be made in the context of a mobile communication system. Therefore, while terms “data” and “traffic” indicate a data packet, they also indicate an ATM cell in the ATM system. Similarly, while congestion indicating information is described as an EFCI in an ATM cell format, it is not limited to the EFCI.

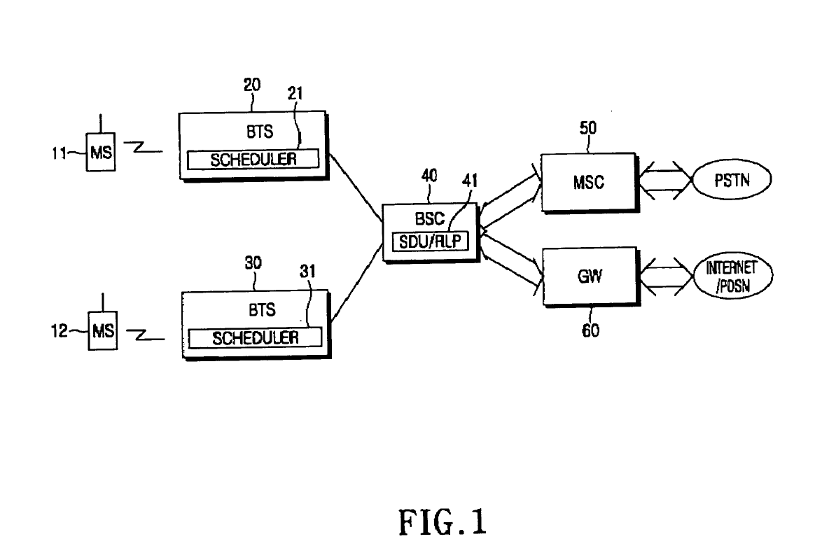

FIG. 1 illustrates the network configuration of a mobile communication system to which the present invention is applied. The mobile communication system supports packet service as well as voice service to mobile subscribers. The structure illustrated in FIG. 1 is a generalized one, and the components are termed depending on which system is used (e.g., IS-2000, WCDMA, UMTS, CDMA2000, 1×EV-DO, GPRS, and 1×EV-DV).

Referring to FIG. 1, the mobile communication system includes MSs 11 and 12, BTSs 20 and 30 connected wirelessly to the MSs 11 and 12 for communication, and a BSC 40 connected to the BTSs 20 and 30 for communication. The BSC 40 is connected to an MSC 50 and a gateway (GW) 60. The MSC 50 is connected to a PSTN (Public Switched Telephone Network) and the GW 60 is connected to the Intemet/PDSN(Packet Data Serving Node). When the MS 11 is connected to the PSTN via the MSC 50 under the control of the BSC 40, a voice service is provided to the MS 11. If the MS 11 is connected to the Internet/PDSN via the GW 60, a packet service is provided to the MS 11.

The BTSs 20 and 30 have RF (Radio Frequency) schedulers 21 and 31, respectively, and the BSC 40 includes an SDU (Selection & Distribution Unit) /RLP processor 41. The RF schedulers 21 and 31 enable the BTSs 20 and 30 to use radio resources efficiently and assign the radio resources appropriately to a plurality of users. The SDU processor 41 functions to transmit traffic to a plurality of BTSs and combine the same data received from an MS through a BTS. While the SDU processor 41 may be located in the GW 60, it is assumed that the SDU processor 41 is provided within the BSC 40. The RLP processor 41 converts packets received from the GW 60 in an error control protocol frame structure for transmission to the BTSs 20 and 30. Notably, the BTSs 20 and 30 have limited buffer space for users. Therefore, if the BTSs 20 and 30 receive traffic that is larger than can be accommodated from the BSC 40, the BTSs 20 and 30 experience traffic loss. To prevent the traffic loss, flow control is performed. In one embodiment of the present invention, a data congestion control is performed as a flow control. That is, it is determined whether data congestion has occurred in a data transmission period, the determination result is notified, and a data congestion control is performed correspondingly.

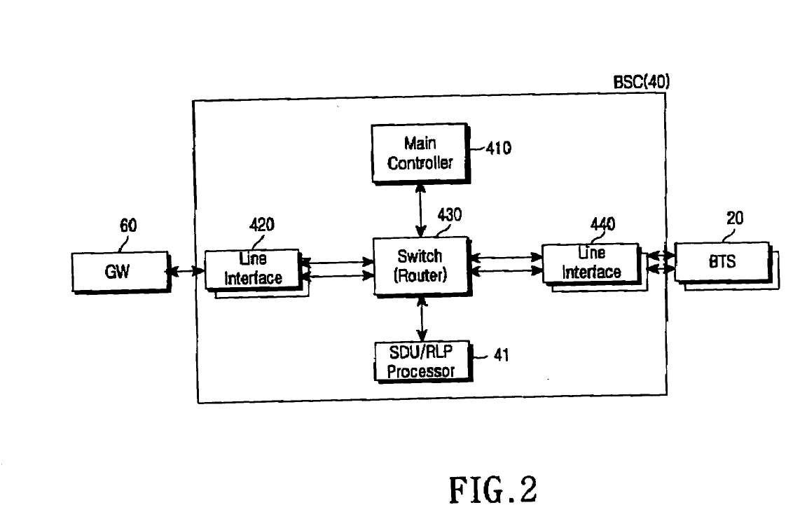

FIG. 2 is a block diagram of the BSC 40 illustrated in FIG. 1. Referring to FIG. 2, the BSC 40 comprises a main controller 410, a line interface (or network interface) 420, a switch (or router) 430, and another line interface 440. The main controller 410 provides overall control to the BSC 40. The line interface 420 connects the BSC 40 to the GW 60, and the line interface 440 connects the BSC 40 to the BTS 20. The switch 430 routes traffic within the BSC 40. The SDU processor 41 multiplexes traffic to be transmitted on at least two links and demultiplexes traffic received on the links at a soft handover. The RLP processor 41 supports radio link error correction.

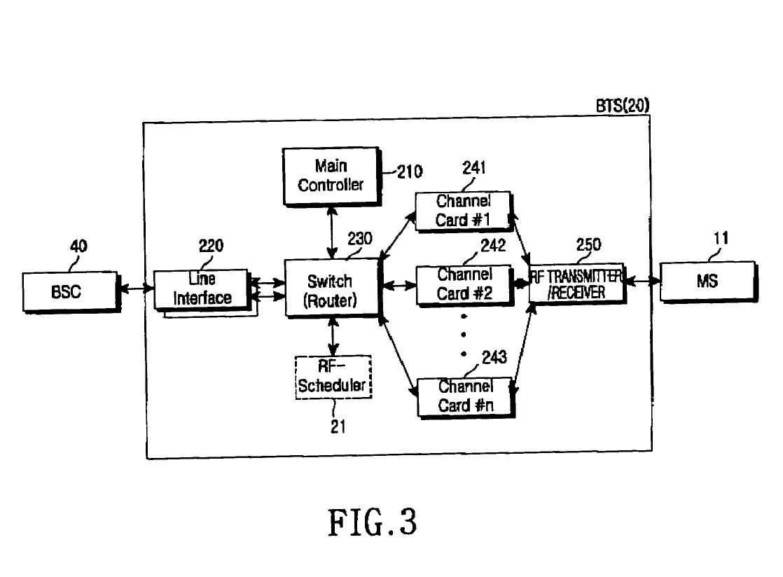

FIG. 3 is a block diagram of the BTS 20 illustrated in FIG. 1. The following description is also applied to the BTS 30.

Referring to FIG. 3, the BTS 20 includes a main controller 210, a line interface 220, a switch (or router) 230, channel cards 241, 242, ... 243, an RF transmitter/receiver 250, and an RF scheduler 21. The main controller 210 provides overall control to the BTS 20. The line interface 220 connects the BTS 20 to the BSC 40. The RF transmitter/receiver 250 exchanges data and control signals with the MS 11. The switch 230 determines a traffic path within the BTS 20. The RF scheduler 21 supports efficient management of radio resources. The RF scheduler 21 may be implemented as an independent processor as shown, or in software within the channel cards 241, 242, . . . , 243.

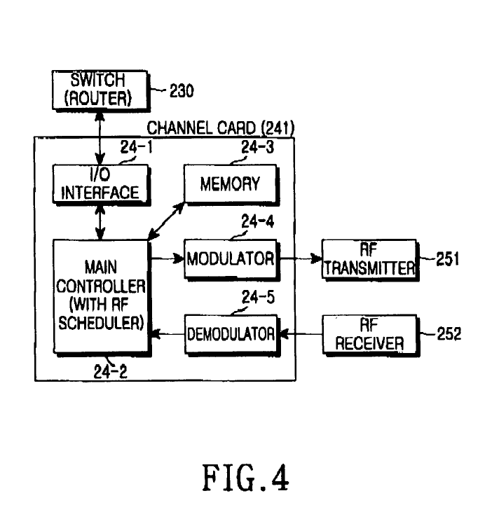

FIG. 4 is a block diagram of the channel card 241 shown in FIG. 3. The same description may apply to the other channel cards 242, . . . 242 shown in FIG. 3. Referring to FIG. 4, the channel card 241 includes an input/output (I/O) interface 24-1, a main controller 24-2, a memory 24-3, a modulator 24-4, and a demodulator 24-5. The I/O interface 24-1 interfaces between the switch 230 and the channel card 241. The modulator 24-4 modulates data and control signals to be transmitted to the MS 11 via the RF transmitter 251 in the RF transmitter/receiver 250. The demodulator 24-5 demodulates data and control signals received from the MS 11 through the RF receiver 252 in the RF transmitter/receiver 250. The memory 24-3 has a buffer for receiving packet data directed to the MS 11 from the BSC 40 and temporarily storing it. The memory 24-3 also stores control information.

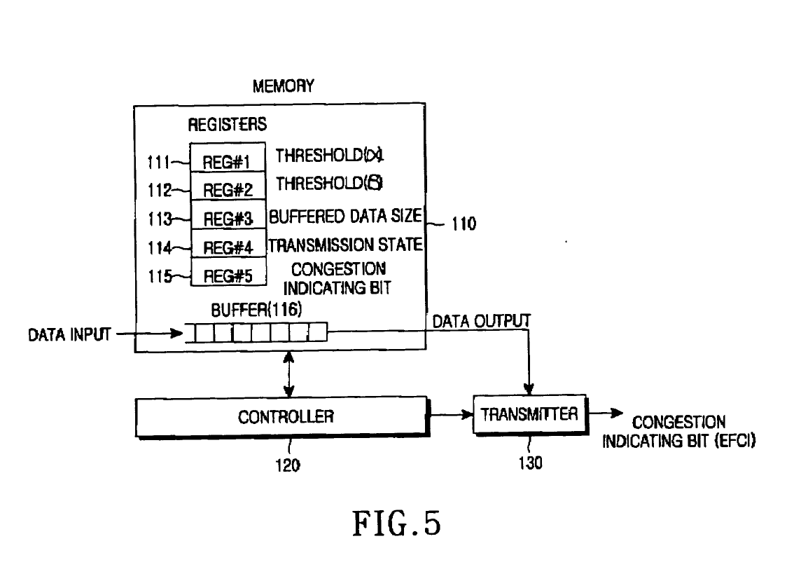

FIG. 5 is a block diagram of a data congestion notifying apparatus according to an embodiment of the present invention. A data congestion control is performed when the BSC 40 transmits data to the GW 60 via the line interface (or network interface) 420, or to the BTS 20 via the line interface 440. When the BTS 20 transmits data to the BSC 40 via the line interface 220, or to the MS 11 via the channel cards 241 to 243 and the RF transmitter/receiver 250, a data congestion control is also performed. That is, the data congestion notifying apparatus may be included in each of the line interfaces 420, 440, and 220 and the channel cards 241 to 243. While a data transmitter notifies data congestion in the description of the present invention, it is to be appreciated that the same thing can occur to a data receiver.

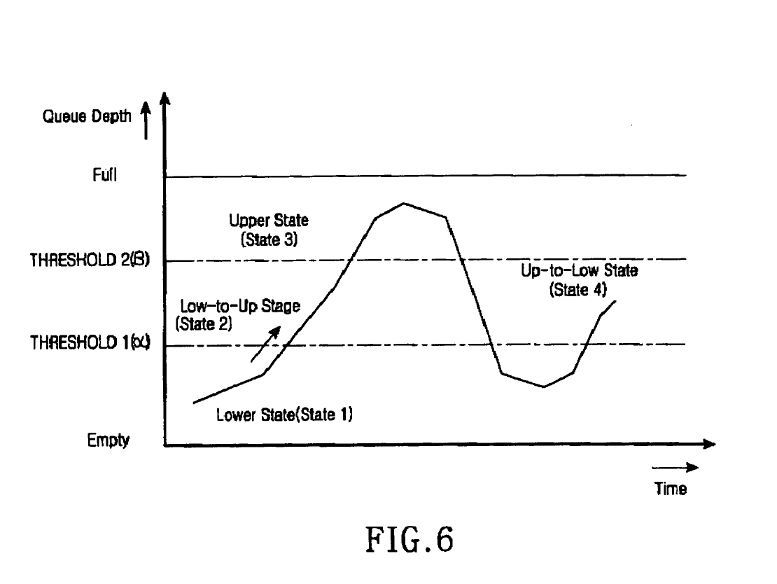

Referring to FIG. 5, the data congestion notifying apparatus is comprised of a memory 110, a controller 120, and a transmitter 130. The memory 110 includes first to fifth registers 111 to 115 and a buffer 116. The buffer 116 stores data received via an input device (not shown) before transmission via an output device (not shown). The first register 111 stores a first threshold α, the second register 112 stores a second threshold β greater than the first threshold α, the third register 113 stores the size of buffered data (i.e., a buffer size count or queue depth), and the fourth register 114 stores a value indicating a transmission state. Transmission states are divided into a first state (lower state), a second state (low-to-up state), a third state (upper state), and a fourth state (up-to-low state). The definition of the transmission states will be provided later with reference to FIG. 6. The fifth register 115 stores bits indicating data congestion (hereinafter, referred to as congestion indicating information). The first and second thresholds are preset to determine whether a current data transmission period is a congestion period. The buffered data size is the amount of buffered data counted by a counter (not shown). The values stored in the fourth 114 and fifth registers 115 are varied according to the buffered data size.

The controller 120 determines the amount of data stored in the buffer 116 and compares the buffered data size with the first and second thresholds. According to the comparison results, the controller 120 determines whether the current data transmission period is a congestion period. If determining that data congestion occurs in the transmission period, the controller 120 controls the transmitter 130 to generate congestion indicating information. The transmitter 130 generates the congestion indication information, for example, an EFCI by setting a predetermined bit to 1 in the header of transmission data and transmits it to a destination node. The destination node transmits a Congestion Indication Message to the source node that transmitted data, requesting a control of the data congestion. The source node then controls a data rate of data to be transmitted to the buffer 116. That is, the source controls the data congestion by, for example, reducing a data rate.

FIG. 6 illustrates a method of congestion indicating information according to an embodiment of the present invention. As illustrated, data congestion occurs as the buffered data size varies with passage of time, that is, during data transmission in progress.

Referring to FIG. 6, when the buffered data size is less than the first threshold α, the transmission state is set as the first state. When the buffered data size is equal to or greater than the first threshold α and less than the second threshold β, the transmission state is set as the second state. When the buffered data size is equal to or greater than the second threshold β, the transmission state is set as the third state. After the third state, when the buffered data size is equal to or greater than the first threshold α and less than the second threshold β, the transmission state is set as the fourth state.

According to the embodiment of the present invention, the controller 120 illustrated in FIG. 5 determines the third and fourth states as an occurrence of data congestion and controls the transmitter 130 to generate congestion indicating information. The congestion indicating information is maintained until the buffered data size is less than the first threshold. That is, if the buffered data size is greater than the second threshold, the transmitter 130 transmits the congestion indicating information to a destination node, notifying data congestion in the current transmission period, until the buffered data size is less than the first threshold.

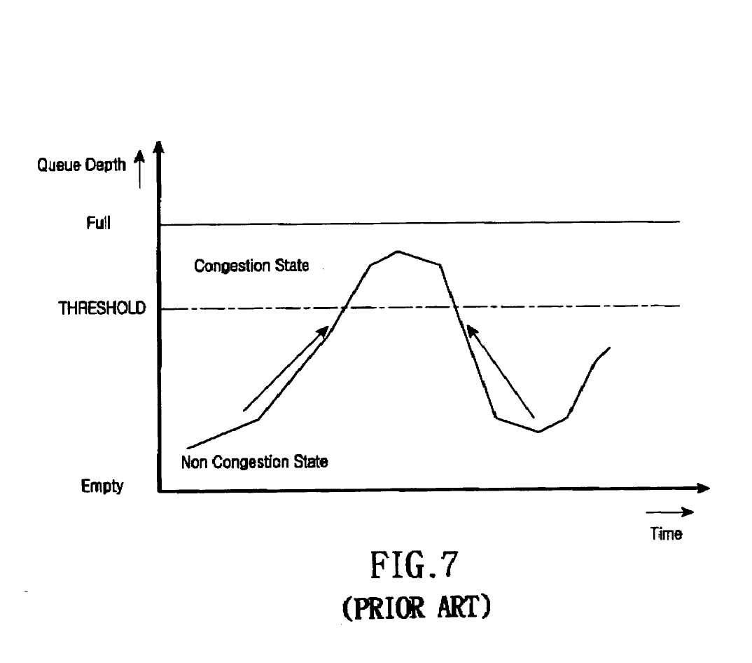

For comparison with the present invention, a conventional method of generating congestion indicating information will be described with reference to FIG. 7.

Referring to FIG. 7, when the buffered data size is greater than a threshold, it is determined that data is congested. A source node then notifies a destination node of the data congestion and the destination node requests the source node to control the data congestion. If the buffered data size is less than the threshold, a data congestion control releases the data congestion status. Due to the use of this single threshold, a congestion period may occur again shortly thereafter, resulting in too frequent alternations between congestion and non-congestion periods, which in turn increases signaling for data congestion control. Moreover, since the communication system is maintained mostly at a threshold level, transmission data is highly likely to be lost.

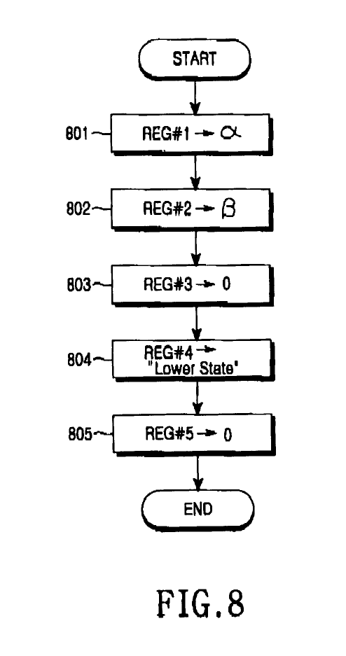

FIG. 8 is a flowchart illustrating in one embodiment initial setting of the registers 111 to 115 illustrated in FIG. 5 in the controller 120.

Referring to FIG. 8, the first register 111 is set to a first threshold α in step 801, and the second register 112 is set to a second threshold β in step 802. The third register 113 is set to 0 in step 803 and the fourth register is set to a first state (lower state) in step 804. In step 805, the fifth register 115 is set to 0.

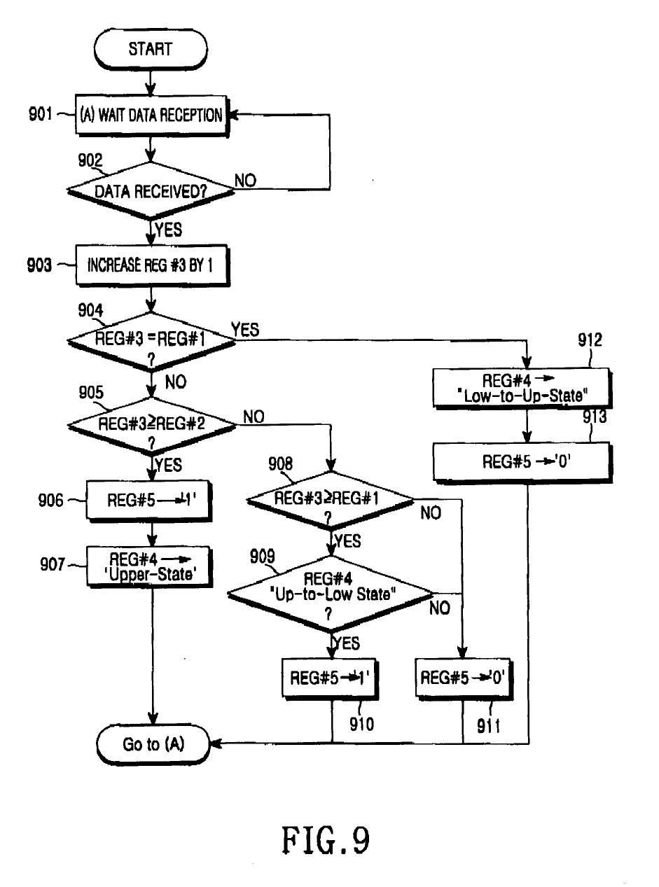

FIG. 9 is a flowchart illustrating received packet processing in the controller 120 of the data congestion notifying apparatus according to an embodiment of the present invention.

Referring to FIG. 9, the controller 120 awaits receipt of data (a packet or an ATM cell) in step 901. Upon receipt of data in step 902, the controller 120 increases the value of the third register 113 by 1 in step 903. In step 904, the controller 120 compares the value of the third register 113 with the value of the first register 111. That is, the controller 120 compares the size of buffered data with the first threshold α. If the buffered data size is equal to the first threshold β, the controller 120 sets the fourth register 114 to the second state (low-to-up state) in step 912 and sets the fifth register 115 to 0 in step 913.

If the buffered data size is different from the first threshold α, the controller 120 compares the value of the third register 113 with the value of the second register 112 in step 905. That is, the controller 120 compares the buffered data size with the second threshold β. If the buffered data size is equal to or greater than the second threshold β, the controller 120 sets the fifth register 115 to 1 in step 906 and sets the fourth register 114 to the third state (upper state) in step 907.

If the buffered data size is less than the second threshold P in step 905, the controller 120 compares the value of the third register 113 with the value of the first register 111 in step 908. That is, the controller 120 compares the buffered data size with the first threshold α. If the buffered data size is equal to or greater than the first threshold α, the controller 120 determines whether the fourth register 114 has been set to the fourth state (up-to-low state) in step 909. If set to the fourth state, the controller 120 sets the fifth register 115 to 1 in step 910. If the buffered data size is less than the first threshold α in step 908, or if the fourth register 114 has not been set to the fourth state in step 909, the controller 120 sets the fifth register 115 to 0, thereby releasing the data congestion state in step 911.

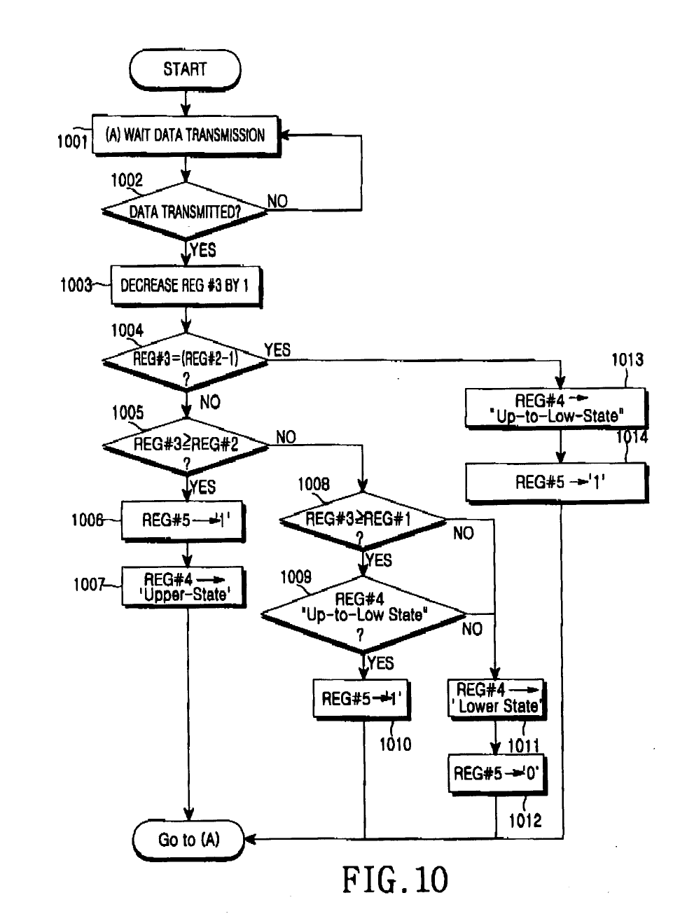

FIG. 10 is a flowchart illustrating transmission packet processing in the controller 120 of the data congestion notifying apparatus according to an embodiment of the present invention.

Referring to FIG. 10, the controller 120 awaits transmission of data (a packet or an ATM cell) in step 1001. When data is transmitted in step 1002, the controller 120 decreases the value of the third register 113 by 1 in step 1003. In step 1004, the controller 120 compares the value of the third register 113 with (the value of the second register 112 minus 1). That is, the controller 120 compares the size of buffered data with (the second threshold β minus 1). If the buffered data size is less than the second threshold β minus 1, the controller 120 sets the fourth register 114 to the fourth state (up-to-low state) in step 1013 and sets the fifth register 115 to 0 in step 1014.

If the buffered data size is not equal to the second threshold β minus 1, the controller 120 determines whether the value of the third register 113 (buffered data size) is equal to or greater than the value of the second register 112 in step 1005. If the buffered data size is equal to or greater than the second threshold β, the controller 120 sets the fifth register 115 to 1 in step 1006 and sets the fourth register 114 to the third state (upper state) in step 1007.

If the buffered data size is less than the second threshold β in step 1005, the controller 120 compares the value of the third register 113 with the value of the first register 111 in step 1008. That is, the controller 120 compares the buffered data size with the first threshold α. If the buffered data size is equal to or greater than the first threshold α, the controller 120 determines whether the fourth register 114 has been set to the fourth state (up-to-low state) in step 1009. In the fourth state, the controller 120 sets the fifth register 115 to 1 in step 1010. If the buffered data size is less than the first threshold α in step 1008, or if the fourth register 114 has not been set to the fourth state in step 1009, the controller 120 sets the fourth register 114 to the first state (lower state) in step 1011 and sets the fifth register 115 to zero in step 1012, thereby releasing the data congestion state.

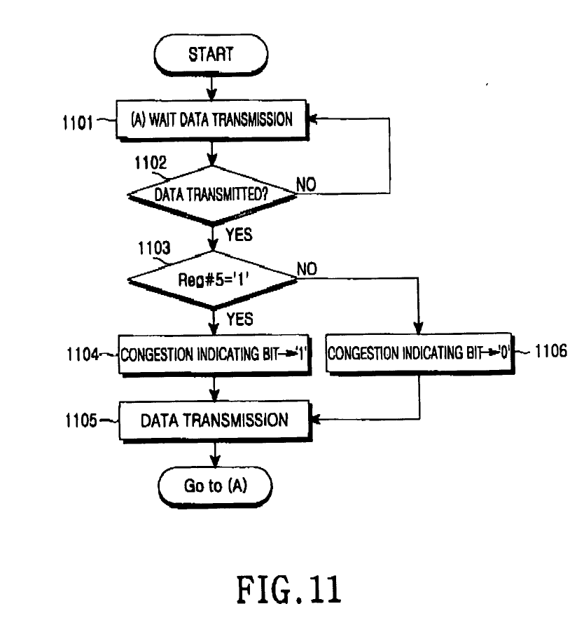

FIG. 11 is a flowchart illustrating a method of setting congestion indication information in the controller 120 of the data congestion notifying apparatus according to an embodiment of the present invention.

Referring to FIG. 11, the controller 120 awaits transmission of data (a packet or an ATM cell) in step 1101. When data is transmitted in step 1102, the controller 120 determines whether the fifth register 115 has been set to 1 in step 1103. If the value of the fifth register 115 is 1, the controller 120 sets a congestion indicating bit to 1 in step 1104 and transmits data with the congestion indicating bit in its header in step 1105. On the other hand, if the value of the fifth register 115 is 0, the controller 120 sets the congestion indicating bit to 0 in step 1106.

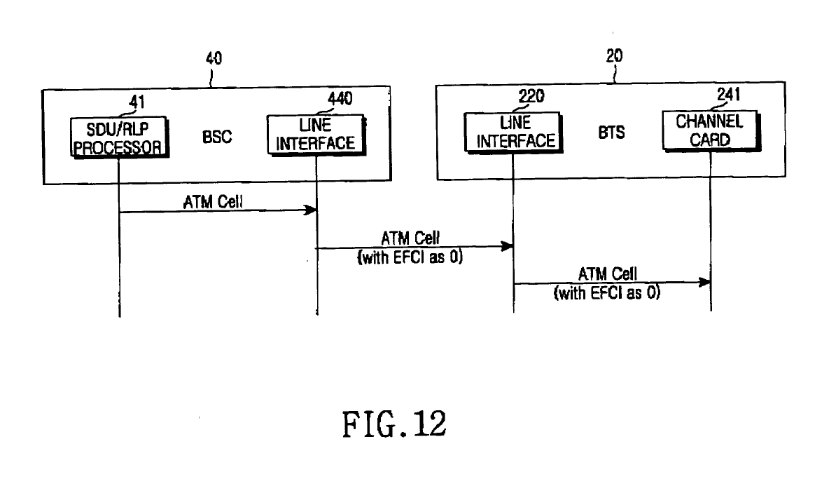

FIGS. 12 are 13 illustrate data congestion control when data congestion does not occur during a data transmission period and when data congestion does occur during a data transmission period according to an embodiment the present invention. While the data congestion control is applied to forward data transmission from the BSC 40 (a first node) to the BTS 20 (a second node) illustrated in FIG. 1, it is also applicable to reverse data transmission from the BTS 20 to the BSC 40.

Referring to FIG. 12, if no data congestion occurs in data (e.g., an ATM cell) transmitted by the SDU/RLP processor 41 of the first node in a transmission line (El or trunk), the line interface 440 sets a congestion indicating bit (e.g., an EFCI) contained in the header of transmission data to 0. In this case, the channel card 241 of the second node does not perform any particular operation.

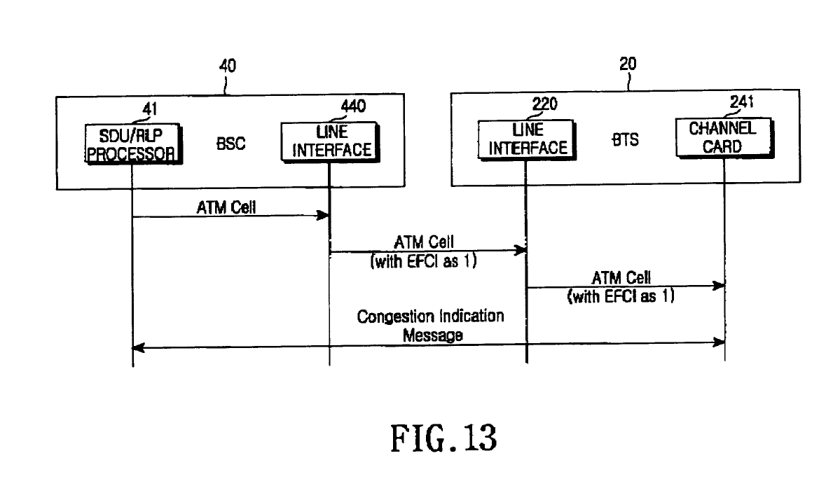

Referring to FIG. 13, if data congestion occurs in data (e.g., an ATM cell) transmitted by the SDU/RLP processor 41 of the first node in the transmission line (El or trunk), the line interface 440 sets the congestion indicating bit (e.g., an EFCI) contained in the header of transmission data to 1. In this case, the channel card 241 of the second node transmits a Congestion Indication Message to the SDU/RLP processor 41, requesting control of the data congestion. The Congestion Indication Message can be transmitted as a separate message or by in-band signaling. Then the SDU/RLP processor 41 releases the data congestion by controlling a forward data rate, for example.

In accordance with the present invention as described above, it is determined whether transmission data congestion has occurred using two thresholds, the determination result is notified, and a data congestion control is performed correspondingly. The resulting decrease in the interval between a congestion period and a non-congestion period reduces signaling for data congestion control and obviates the need for frequent data rate changes in a transmitter and a receiver. Therefore, the stable data rates are maintained.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of controlling data congestion of a buffer for storing transmission data in a first node that transmits the transmission data to a second node in a communication system, comprising:
comparing a buffered data size of data stored in the buffer with a predetermined first threshold, and comparing the buffered data size with a predetermined second threshold greater than the first threshold by the first node;
determining that data congestion has occurred if the buffered data size is equal to or greater than the second threshold, and notifying the second node of the data congestion by the first node;
in response to the notification of the data congestion, generating and transmitting a congestion indication message requesting control of the data congestion by the second node; and
upon receipt of the congestion indication message, controlling a data rate of data to be transmitted to the buffer by the first node.

2. The method of claim 1, further comprising the step of stopping by the first node notifying the second node of the data congestion if the buffered data size is less than the first threshold.

3. The method of claim 1, wherein the step of notifying of the data congestion continues until the buffered data size is less than the first threshold.

4. The method of claim 2, wherein the notification of the data congestion is performed by using a predetermined bit of a header of the transmission data.

5. The method of claim 1, wherein the transmission data is an ATM (Asynchronous Transfer Mode) cell.

6. An apparatus of controlling data congestion in a communication system, comprising:
a first node having a buffer for storing transmission data; and
a second node receiving the transmission data from the first node,
wherein said first node further comprises a controller for comparing a buffered data size of data stored in the buffer with a predetermined first threshold, comparing the buffered data size with a predetermined second threshold greater than the first threshold by the first node, and determining that data congestion has occurred if the buffered data size is equal to or greater than the second threshold, a transmitter for, under the control of the controller, generating congestion indication information and transmitting the congestion indication information to the second node, and a processor for controlling a data rate of data to be transmitted to the buffer, and said second node comprises a transmitter for, upon receipt of the congestion indication information, transmitting a congestion indication message requesting control of the data congestion.

7. The apparatus of claim 6, wherein the controller controls the transmitter of said first node so as to stop transmitting the congestion indication information if the buffered data size is less than the first threshold.

8. The apparatus of claim 6, wherein the transmitter of said first node transmits the congestion indication information until the buffered data size is less than the first threshold.

9. The apparatus of claim 7, wherein the congestion indication information is transmitted in a predetermined bit contained of a header of the transmission data.

10. The apparatus of claim 6, wherein the transmission data is an ATM (Asynchronous Transfer Mode) cell.
